(19) United States
(12) Patent Application Publication
(10) Pub. No.: US 2004/0017333 A1
(43) Pub. Date: Jan. 29, 2004

(54) Universal serial bus display unit

(76) Inventors: Alan Neal Cooper, Coppell, TX (US); Christopher Michael Fritz, Dallas, TX (US); James Walter Exner, Plano, TX (US)

Correspondence Address: Raffi Gostanian, Jr.,, Jackson Walke L.L.P., Suite 600, 2435 North Central Expressway, Richardson, TX, 75080, US

(21) Appl. No.: 10/202,257

(22) Filed: Jul. 24, 2002

(51) Int. Cl. G09G 5/00

(52) U.S. Cl. 345/3.1

(57) ABSTRACT

The present invention provides a universal serial bus (USB) display unit comprising a microprocessor with a USB interface, where the USB interface is adapted to receive video data from a first source, and a video decoder adapted to receive other video data from a second source. The USB unit also comprises a field-programmable gate array (FPGA) adapted to process the video data and the other video data, a memory adapted to store the processed video data and the processed other video data, and a display adapted to contemporaneously display the processed video data and the processed other video data. The microprocessor is adapted to transmit the processed other video data to the first source via the USB interface which is adapted to receive audio data from the first source. The USB unit further comprises an audio circuit adapted to provide the audio data via the FPGA, where the video decoder, the audio circuit, the microprocessor, the display, and the memory are operably coupled to the FPGA.

### RELATED APPLICATIONS

The present invention is related to patent application [docket number 120745.00001] titled DIGITAL OBSERVATION SYSTEM, to patent application [docket number 120745.00002] titled DIGITAL TRANSMISSION SYSTEM, and to patent application [docket number 120745.00003] titled DIGITAL CAMERA SYNCHRONIZATION. These applications are commonly assigned, commonly filed, and are incorporated by reference herein.

### FIELD OF THE INVENTION

The present invention relates to monitors for displaying video images and, more particularly, to a universal serial bus display unit adapted to display multimedia images.

### BACKGROUND OF THE INVENTION

When utilizing a personal computer (PC), a user typically inputs commands to the PC, via user interfaces such as a keyboard and mouse, and outputs are displayed on a PC monitor based on the input commands. There are scenarios, however, in which the PC user may want to concurrently perform multiple tasks or run certain applications on the PC and view video simultaneously from sources such as a security camera, a DVD player, cable TV, etc. There are various solutions for performing these task but all include the limitation of using a PC processor or platform to view the video signal. A further limitation involves a user accessing built in operating system capabilities such as a multi-screen operation. In such a scenario, the user is required to have a PC platform with, or the addition of, a second display driver.

It is therefore desirable for the present invention to overcome the limitations described above that are involved in concurrently performing multiple tasks on the PC and viewing video simultaneously from various sources.

### SUMMARY OF THE INVENTION

The present invention achieves technical advantages as a universal serial bus (USB) display unit adapted to display multimedia images. In an exemplary embodiment, a USB display unit comprises a microprocessor with a USB interface, where the USB interface is adapted to receive video data from a first source, and a video decoder adapted to receive other video data from a second source. The USB unit also comprises a field-programmable gate array (FPGA) adapted to process the video data and the other video data, a memory adapted to store the processed video data and the processed other video data, and a display adapted to contemporaneously display the processed video data and the processed other video data. The microprocessor is adapted to transmit the processed other video data to the first source via the USB interface which is adapted to receive audio data from the first source. The USB unit further comprises an audio circuit adapted to provide the audio data via the FPGA, where the video decoder, the audio circuit, the microprocessor, the display, and the memory are operably coupled to the FPGA.

### BRIEF DESCRIPTION OF THE DRAWINGS

FIG. 1 illustrates a USB display unit operably coupled to a PC and a video source in accordance with an exemplary embodiment of the present invention.

FIG. 2 illustrates a block diagram of the USB display unit in accordance with an exemplary embodiment of the present invention.

FIG. 3 illustrates a flow chart for transferring data between a second module that is operably coupled to a first module and a third module in accordance with an exemplary embodiment of the present invention.

FIG. 4 illustrates a further flow chart for transferring data between a second module that is operably coupled to a first module and a third module in accordance with an exemplary embodiment of the present invention.

### DETAILED DESCRIPTION OF THE INVENTION

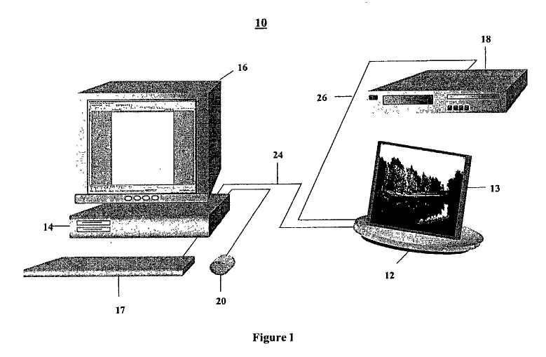

Referring now to FIG. 1, a system 10 is presented which includes a USB display unit 12 operably coupled to a USB monitor or display 13, a PC 14 operably coupled to a PC monitor 16 (for purposes of this invention, the term PC 14 shall mean the PC 14 and the PC monitor 16 unless otherwise stated), and a video source 18. Commands are received at the PC 14 via devices such as a keyboard 17 and a mouse 20. The USB display unit 12 is operably coupled to the PC 14 via a connection 24 and to the video source 18 via a connection 26. The connection 24 is a USB connection to the PC's USB which is a “plug and play” port. This USB connection 24 allows video images to be transferred and received at the USB display unit 12 where they may be displayed via the display 13 without utilizing the PC's 14 microprocessor (not shown) and/or platform (not shown). This connection 24 enhances the PC 14 and the USB display unit 12 without additional hardware having to be added to either device.

The PC 14 includes a software application which, when activated, converts an image (which may be retrieved from, for example, hyper-text markup language pages, spreadsheets, and other applications) to a bitmap that can be transferred to the USB display unit 12 via the connection 24. In such a scenario, the USB display unit 12 operates as a multimedia secondary monitor for the PC's 14 applications. Similarly, any displayed image on the USB display unit 12 from the video source 18 via the connection 26 can be transmitted as a bitmap to the PC 14. The PC 14 can then store the image, display the image, or retransmit the image. A user can utilize the USB display unit 12 as a video viewing station that can be controlled from the PC 14 via the connection 24 and also use the connection 24 to select images received from the video source 18 to transfer to the PC.

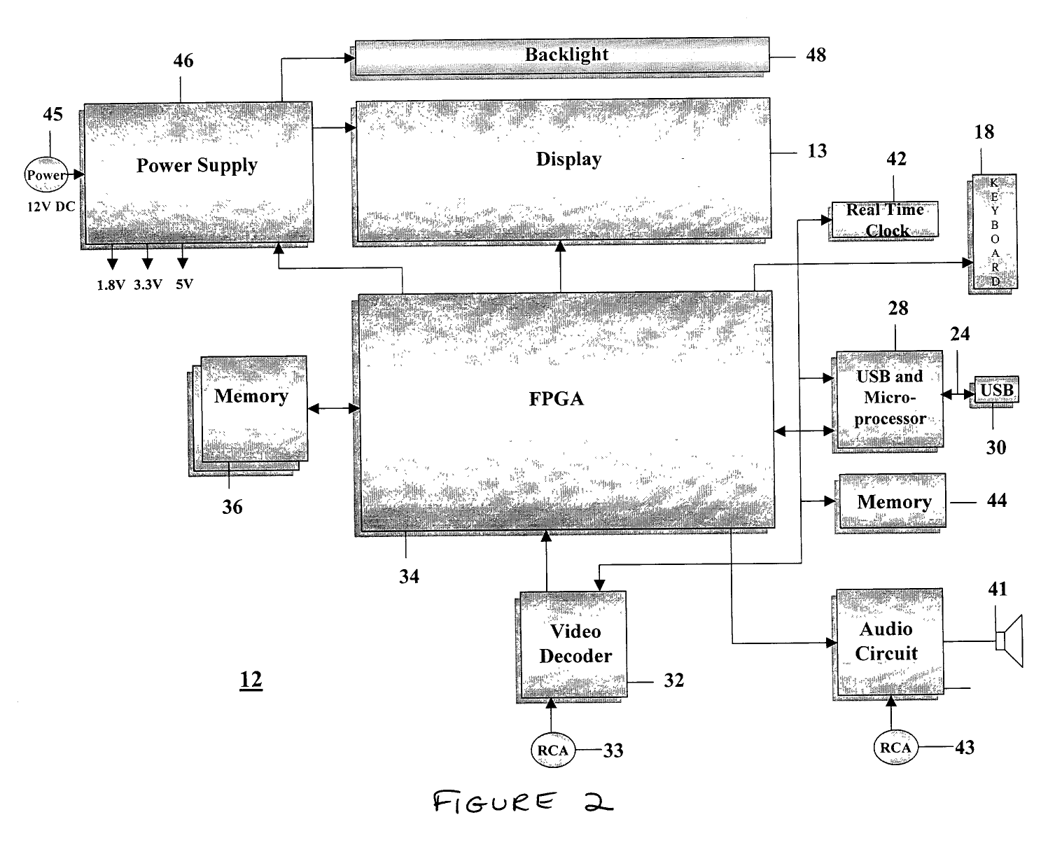

Referring now to FIG. 2, the USB display unit 12 is presented which comprises a microprocessor including a USB interface 28 that receives (or is adapted to receive) video data from a first source, such as the PC 14 via a physical USB interface or data port 30, and a video decoder 32 that receives other video data from a second source, such as the video source 18, via a connection plug 33. The microprocessor 28 manages and controls the operational functions of the display unit 12 including managing the display 13 and also controls the user interface. The microprocessor 28 further controls the USB interface and the data associated with it including data flow management, data transfer and reception. The video decoder 32 is used to digitize the incoming analog video signal and the decoder's 32 output, in an exemplary embodiment, is the spatial resolution of 4:2:2 (intensity:reddishness:blueishness) YUV digital video data. There are a plurality of bits of data for each pixel and horizontal and vertical synchronization signals are output from the decoder 32 in addition to a data valid signal.

A field-programmable gate array (FPGA) 34 processes the video data and the other video data (that may both operate at different data rates) which can be stored in memory 36 and/or contemporaneously displayed via the display or monitor 13. The memory 36 is, in an exemplary embodiment, a synchronous dynamic random access memory (SDRAM).

The FPGA 34 is the primary controller for the functions of the various portions of the display unit 12. One of these functions includes managing (which includes reading, writing, and refreshing) the memory 36 which is utilized to store the images that are to be displayed on the display 13. The data input to the memory 36 is received from the video decoder 32 or the USB microprocessor 28. The memory 36 size is dependant on the screen resolution of the display 13 and can contain multiple images for display as well as buffer memory that will be utilized as a receiving buffer for new images. The output of the memory data is sent to a scalar (not shown) which is located in the FPGA 34 to convert the data to the appropriate data size for the display 13.

Other functions of the FPGA 34 include controlling the data flow from the USB data port 30, the video decoder 32, the memory 36, and the display 13, interfacing to the display, developing all the necessary signals for a time-base of the display, direct memory access controlling of the data from the microprocessor 28 to the memory 36, managing the user interfaces, transmitting the data to the microprocessor, generating an On Screen Display thereby enabling a user to program and adjust display parameters, buffering video data as it transfers from different circuit areas that operate at different data rates and scaling the video data to be displayed to the appropriate resolution for the display 13. Further functions include performing video processing such as enhancing the video by controlling the contrast, brightness, color saturation, sharpness, and color space conversion of the video data that is received from the video decoder 32 or the USB data port 30, and receiving data from the video decoder 32, which digitizes an analog video signal.

The microprocessor 28 transmits the FPGA 34 processed other video data to the first source via the USB port 30 which further receives audio data from the first source. An audio circuit 40 provides the audio data via the FPGA 34 which is operably coupled to the microprocessor 28, the video decoder 32, the memory 36, the display 13, and the audio circuit 40. The audio circuit 40 takes the audio data and amplifies it for output to a speaker 41. Audio information can also be received via the connection plug 43 and can also be sent over the USB port 30 for output provided a D/A converter was present in the audio circuit. A real-time clock 42 transmits and receives time and date information between the video decoder 32, the microprocessor 28 and a second memory 44 and further stores configuration registers and timer functions. The second memory 44, which is operably coupled to the microprocessor 28 and the video decoder 32, maintains operation code of the microprocessor. The USB display unit 12 operates from an external 12V DC wall mount power supply 45 that supplies all the power necessary for the display unit 12 to operate. A power supply 46 is designed to protect the display unit 12 from excess voltage inputs and to filter any noise from entering or exiting the display unit. The power supply 46 further creates multiple DC voltages (such as 1.8V, 3.3V, and 5V) to supply the various portions of the display unit 12. The display unit 12 may further be controlled by a keyboard 19 which is operably coupled to the FPGA 34.

In an exemplary embodiment, the display 13 is a video display monitor utilizing an LCD active matrix display with a VGA resolution of 640 pixels by 480 lines (although the resolution could be higher or lower). The interface to the display 13 is comprised of a plurality of logic level clock signals that are used for clocking, synchronization, and data transfer. The power supply module 46, which receives power from an external adapter, creates a plurality of voltages to supply the display 13 and a backlight 48. The backlight 48 applies a voltage to tubes (not shown) that illuminate the display 13, where the tubes are operably coupled to the monitor.

The USB display unit 12 has two primary connections. The first is a Video/Audio input port for composite video and line level audio input, while the second is a USB 1.1, 2.0 or similar connection. The USB port is a slave type device, which means it must connect to a master type USB host. The display unit 12 can be operated by either the video input connection or the USB connection or both ports. When only the video connection is attached, the display unit 12 will operate like a normal video monitor. When the USB port is the only connection the display will show bitmap images transferred to the display over the USB connection. Each of the file formats would be converted in an application running on the PC 14 to a bitmap form (in other embodiments, the data could be sent in other forms such as YUV and the FPGA could convert to USB). When the USB monitor 13 receives the complete image it will display it. Depending on the transfer rate and the file size of the image, motion video can be displayed on the monitor 13 from data sent over the USB connection. The display unit 12 will have enough memory, such as the memory 36, to store a number of images so that the rate for switching display images is not effected by the transfer time of the data sent by the PC 14 over the USB connection 26.

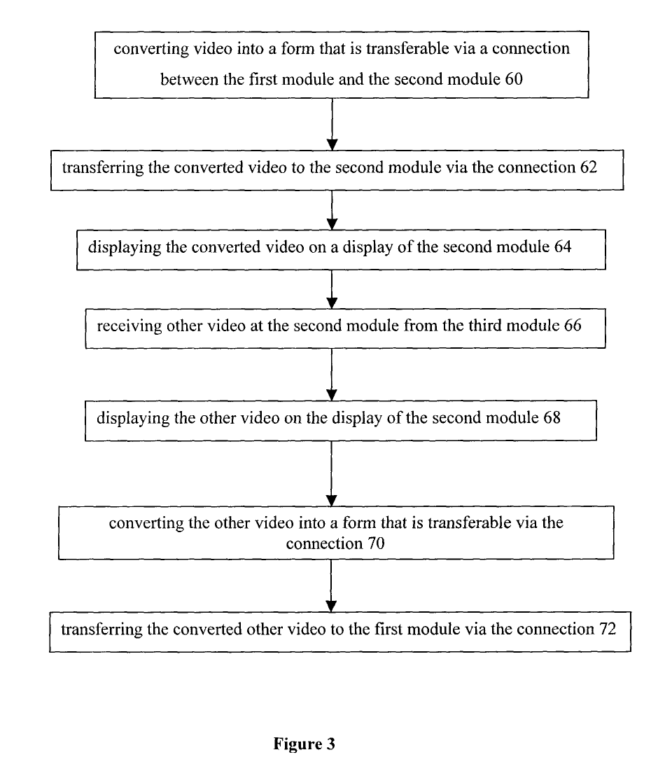

Referring now to FIG. 3, a flow chart of a method for transferring data between a second module (for example, the USB display unit 12) that is operably coupled to a first module (for example, the PC 14) and a third module (for example, the video source 18) is presented. The method begins at step 60 where video is converted into a form that is transferable via a connection (such as a universal serial bus connection) between the first module and the second module. This conversion is performed by an application running on the first module. At step 62, the converted video is transferred to the second module via the connection and, at step 64, is displayed on a display of the second module. The method proceeds to step 66 where other video is received at the second module from the third module (via a video input) and, at step 68, is displayed on the display of the second module. At steps 70 and 72, respectively, the other video is converted into a form that is transferable via the connection, and the converted other video is transferred to the first module via the connection. This conversion is performed by an application running on the second module. Audio may also be transferred between the first module and the second module via the connection and between the third module and the second module via an audio input.

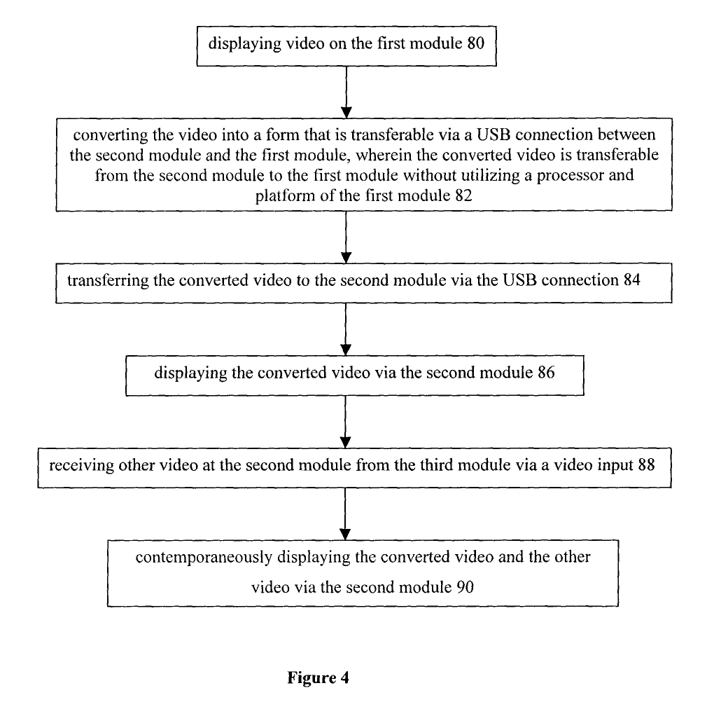

Referring now to FIG. 4, a further flow chart of a method for transferring data between a second module that is operably coupled to a first module and a third module is presented. The method begins at step 80 where video is displayed on the first module. At step 82, the video is converted into a form that is transferable via a universal serial bus (USB) connection between the second module and the first module. The converted video is transferable from the second module to the first module without utilizing a processor and platform of the first module. At steps 84 and 86, respectively, the converted video is transferred to the second module via the USB connection, and is displayed via the second module. The method proceeds to step 88 where other video is received at the second module from the third module via a video input and, at step 90, the converted video and the other video are contemporaneously displayed via the second module.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the resolution on the USB monitor 13 can be greater than VGA including XGA (1024×768), QVGA (1280×960), SXGA (1280×1024), SXGA+(1400×1050), UXGA (1600×1200), etc. Further, a CRT display, plasma display, etc. may be used with the present invention. Also, other types of memory other than the SDRAM memory 36 and a plurality of these memories may be used. Additionally, the USB monitor 13 may dynamically display received images. Still further, other spatial resolutions of YUV digital video data can be output from the decoder 32 and the data transferred over the USB port can be of many forms with the appropriate converter at either end.

What we claim is:

1. A universal serial bus (USB) display unit comprising:
a microprocessor with a USB interface, wherein the USB interface is adapted to receive video data from a first source;
a video decoder adapted to receive other video data from a second source;
a field-programmable gate array (FPGA) adapted to process the video data and the other video data;
a memory adapted to store the processed video data and the processed other video data;
a display adapted to contemporaneously display the processed video data and the processed other video data;
wherein the microprocessor is adapted to transmit the processed other video data to the first source via the USB interface;
wherein the USB interface is adapted to receive audio data from the first source; and
an audio circuit adapted to provide the audio data via the FPGA, wherein the video decoder, the audio circuit, the microprocessor, the display, and the memory are operably coupled to the FPGA.

2. The USB display unit of claim 1 further comprising a real-time clock adapted to transmit and receive timing information between the video decoder, the microprocessor and a second memory, wherein the real-time clock is operably coupled to the video decoder, the microprocessor and the second memory.

3. The USB display unit of claim 2, wherein the second memory is adapted to maintain operation code of the microprocessor, and wherein the second memory is operably coupled to the microprocessor and the video decoder.

4. The USB display unit of claim 1 further comprising a power supply module adapted to receive power from an external adapter and create a plurality of voltages to supply the display and a backlight.

5. The USB display unit of claim 4, wherein the backlight is adapted to apply one of the plurality of voltages to tubes adapted to illuminate the display, wherein the tubes are operably coupled to the display.

6. A universal serial bus (USB) display unit comprising:
a microprocessor with a USB interface, wherein the USB interface is adapted to receive video data from a first source;
a video decoder adapted to receive other video data from a second source;
a field-programmable gate array (FPGA) adapted to process and initiate a storing of the video data and the other video data that operate at different data rates;
memory adapted to store the processed video data and the processed other video data;
a display adapted to contemporaneously display the stored processed video data and the stored processed other video data; and
wherein the microprocessor is adapted to transmit the processed other video to the first source via the USB interface, wherein the video decoder, the microprocessor, the display, and the memory are operably coupled to the FPGA.

7. A field-programmable gate array (FPGA) comprising:
an input adapted to receive video via a video decoder;
an input adapted to receive video via a universal serial bus (USB) interface;
an output adapted to store the received videos in memory;
an input adapted to receive the stored videos; and
an output to a display, wherein the display is adapted to display the stored videos.

8. The FPGA of claim 7 further comprising logic adapted to read, write, and refresh the stored videos.

9. The FPGA of claim 7 further comprising logic adapted to control a rate the videos are received.

10. The FPGA of claim 7 further comprising logic adapted to enhance the received video by altering at least one of: a contrast, a brightness, a color saturation, a sharpness, and a color space conversion.

11. The FPGA of claim 7 further comprising logic adapted to interact with a time-base of the display.

12. The FPGA of claim 7 further comprising logic adapted to digitize the received video from the video decoder.

13. The FPGA of claim 7 further comprising logic adapted to control the video between the USB connection and the memory.

14. The FPGA of claim 7 further comprising logic adapted to transmit the video decoder video to a microprocessor operably coupled to the FPGA and the USB interface.

15. The FPGA of claim 7 further comprising logic adapted to enable a user to program parameters on the display.

16. The FPGA of claim 7 further comprising logic adapted to store the videos in the memory as they are received at the FPGA at different data rates.

17. The FPGA of claim 7 further comprising logic adapted to scale the videos to an appropriate display resolution.

18. The FPGA of claim 7 further comprising logic adapted to create, modify and delete functions of the display via commands received from a keyboard interface that is operably coupled to the FPGA.

19. The FPGA of claim 7 further comprising an output to a power supply, wherein the power supply is adapted to create a voltage to contemporaneously display the stored videos.

20. A universal serial bus (USB) display unit comprising:
a monitor;
a video port; and
a USB slave port; wherein the monitor is operably coupled to the unit via the video port and the USB slave port;
wherein the unit operates as a video display when the video port is connected to a video source;
wherein the unit operates as a bitmap display when the USB slave port is connected to a computer; and
wherein the video and the bit map are contemporaneously displayed via the monitor.

21. A method for transferring data between a second module that is operably coupled to a first module and a third module, the method comprising:
converting video into a form that is transferable via a connection between the first module and the second module;
transferring the converted video to the second module via the connection;
displaying the converted video on a display of the second module;
receiving other video at the second module from the third module;
displaying the other video on the display of the second module;
converting the other video into a form that is transferable via the connection; and
transferring the converted other video to the first module via the connection.

22. The method of claim 21 further comprising transferring audio between the first module and the second module via the connection.

23. The method of claim 21 further comprising transferring audio between the third module and the second module via an audio input.

24. The method of claim 21, wherein the converting of the video is performed by an application running on the first module.

25. The method of claim 21, wherein the converting of the other video is performed by an application running on the second module.

26. The method of claim 21, wherein the connection is via a universal serial bus.

27. The method of claim 21, wherein the second module receives the other video via a video input.

28. A method for transferring data between a second module that is operably coupled to a first module and a third module, the method comprising:
displaying video on the first module;
converting the video into a form that is transferable via a universal serial bus (USB) connection between the second module and the first module, wherein the converted video is transferable from the second module to the first module without utilizing a processor and platform of the first module;
transferring the converted video to the second module via the USB connection;
displaying the converted video via the second module;
receiving other video at the second module from the third module via a video input; and
contemporaneously displaying the converted video and the other video via the second module.
